(19) United States
(12) Patent Application Publication
(10) Pub. No.: US 2010/0106995 A1
(43) Pub. Date: Apr. 29, 2010

(54) MODE PROCESSING APPARATUS

(75) Inventor: Yoichi FUKAMI, Osaka-fu (JP)

Correspondence Address: NOVAK DRUCE + QUIGG LLP, 1300 EYE STREET NW, SUITE 1000 WEST TOWER, WASHINGTON, DC, 20005, US

(73) Assignee: SANYO ELECTRIC CO., LTD., Osaka (JP)

(21) Appl. No.: 12/606,392

(22) Filed: Oct. 27, 2009

(30) Foreign Application Priority Data
Oct. 27, 2008 (JP) 2008-275062

(51) Int. Cl. G06F 9/318; G06F 1/28

(52) U.S. Cl. 713/340; 712/229; 712/E09.035

(57) ABSTRACT

A mode processing apparatus includes an MCU. The MCU executes a processing operation according to one of an audio reproducing mode and an audio recording mode, by using a battery as a power supply. Also, the MCU cyclically determines, in parallel with the processing operation according to an operating mode at a current time point, whether or not a terminal voltage Vbat of the battery is equal to or less than a threshold value. When a determination result indicating the terminal voltage Vbat≦the threshold value is continued, the MCU requests to stop the processing operation according to the operating mode at a current time point. Moreover, the MCU adjusts a length of a cycle in which the above-described determining process is performed to a length different depending on each operating mode.

### CROSS REFERENCE OF RELATED APPLICATION

The disclosure of Japanese Patent Application No. 2008-275062, which was filed on Oct. 27, 2008, is incorporated herein by reference.

### BACKGROUND OF THE INVENTION

1. Field of the Invention

The present invention relates to a mode processing apparatus. More particularly, the present invention relates to a mode processing apparatus for executing a processing operation according to any one of a plurality of operating modes under a battery power supply.

2. Description of the Related Art

According to one example of this type of apparatus, an average value of a power supply voltage (=Vavg) is cyclically determined. When a current operating mode is a voltage controlling mode, the average value Vavg is compared with a threshold value Vth1, and when the current operating mode is a mixed mode, the average value Vavg is compared with a threshold value Vth2. When Vavg<Vth1 is determined in the voltage controlling mode, the operating mode is modified from the voltage controlling mode to the mixed mode. Furthermore, when Vavg>Vth2 is determined in the mixed mode, the operating mode is modified from the mixed mode to the voltage controlling mode.

Herein, the “voltage controlling mode” is equivalent to a mode of selecting, as a power supply voltage, a drop voltage outputted from a buck circuit. On the other hand, the “mixed mode” is equivalent to a mode of selecting, as the power supply voltage, both a battery voltage and the drop voltage in a mixed state.

However, in the above-described apparatus, although a magnitude of the threshold value which is compared with the average value of the power supply voltage differs depending on each operating mode, a cycle in which the average value of the power supply voltage is determined is constant irrespective of the operating mode. Thus, in the above-described apparatus, it is probable that the processing operation according to the operating mode becomes unstable.

### SUMMARY OF THE INVENTION

A mode processing apparatus according to the present invention comprises: a processor for executing a processing operation according to any one of a plurality of operating modes under a battery power supply; a determiner for cyclically determining, in parallel with the processing operation of the processor, whether or not a voltage fluctuation of the battery power supply matches a predetermined condition; a requester for requesting the processor to stop the processing operation when a determination result of the determiner is updated from a negative result to an affirmative result; and an adjuster for adjusting a length of a determining cycle of the determiner to a length different depending on each operating mode noticed by the processor.

Preferably, the adjuster shortens the length of the determining cycle with an increase in a power consumption.

Preferably, the processing operation executed by the processor includes an access operation to access a recording medium.

Preferably, the predetermined condition includes a voltage value condition under which a voltage value of the battery power supply is equal to or less than a threshold value.

Preferably, the predetermined condition includes a voltage drop amount condition under which a voltage drop amount of the battery power supply exceeds a reference.

More preferably, further comprised is a modifier which modifies a content of the reference according to the operating mode noticed by the processor.

Preferably, the reference includes a first reference in which a plurality of voltage drop amounts respectively corresponding to a plurality of time points different to one another all exceed the threshold value and a second reference in which at least one of a plurality of voltage drop amounts respectively corresponding to a plurality of time points different to one another exceeds the threshold value.

According to the present invention, a mode processing program product executed by a processor of a mode processing apparatus, the mode processing program product comprising: a processing step of executing a processing operation according to any one of a plurality of operating modes under a battery power supply; a determining step of cyclically determining, in parallel with the processing operation in the processing step, whether or not a voltage fluctuation of the battery power supply matches a predetermined condition; a requesting step of requesting the processing step to stop the processing operation when a determination result in the determining step is updated from a negative result to an affirmative result; and an adjusting step of adjusting a length of a determining cycle in the determining step to a length different depending on each operating mode noticed by the processing step.

According to the present invention, a mode processing method executed by a mode processing apparatus, the mode processing method comprising: a processing step of executing a processing operation according to any one of a plurality of operating modes under a battery power supply; a determining step of cyclically determining, in parallel with the processing operation in the processing step, whether or not a voltage fluctuation of the battery power supply matches a predetermined condition; a requesting step of requesting the processing step to stop the processing operation when a determination result of the determining step is updated from a negative result to an affirmative result; and an adjusting step of adjusting a length of a determining cycle in the determining step to a length different depending on each operating mode noticed by the processing step.

A mode processing apparatus according to the present invention comprises: a processor which executes a predetermined processing operation under a battery power supply; a determiner which cyclically determines, in parallel with the processing operation in the processor, whether or not a voltage fluctuation of the battery power supply matches a predetermined condition; a requester which requests the processor to stop the processing operation when a determination result in the determiner is updated from a negative result to an affirmative result; and an adjuster which adjusts a length of a determining cycle in the determiner to a length different depending on each magnitude of a voltage of the battery power supply.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a configuration of one embodiment of the present invention;

FIG. 2(A) is an illustrative view showing one example of a transition of an operating mode;

FIG. 2(B) is a waveform chart showing one example of a change of a voltage monitoring cycle;

FIG. 3 is a flowchart showing one portion of an operation of an MCU applied to an embodiment in FIG. 1;

FIG. 4 is a flowchart showing another portion of the operation of the MCU applied to the embodiment in FIG. 1;

FIG. 5 is a flowchart showing still another portion of the operation of the MCU applied to the embodiment in FIG. 1;

FIG. 6(A) is a graph showing one example of a change of a battery voltage;

FIG. 6(B) is a graph showing one example of a change of a battery voltage sensed by an MCU;

FIG. 7 is a flowchart showing one portion of an operation of an MCU applied to another embodiment;

FIG. 8 is a flowchart showing another portion of the operation of the MCU applied to the other embodiment;

FIG. 9 is a flowchart showing one portion of an operation of an MCU applied to still another embodiment;

FIG. 10 is a flowchart showing another portion of the operation of the MCU applied to the still other embodiment;

FIG. 11 is a flowchart showing one portion of an operation of an MCU applied to yet still another embodiment; and

FIG. 12 is a flowchart showing another portion of the operation of the MCU applied to the yet still other embodiment.

### DETAILED DESCRIPTION OF THE PREFERRED EMBODIMENTS

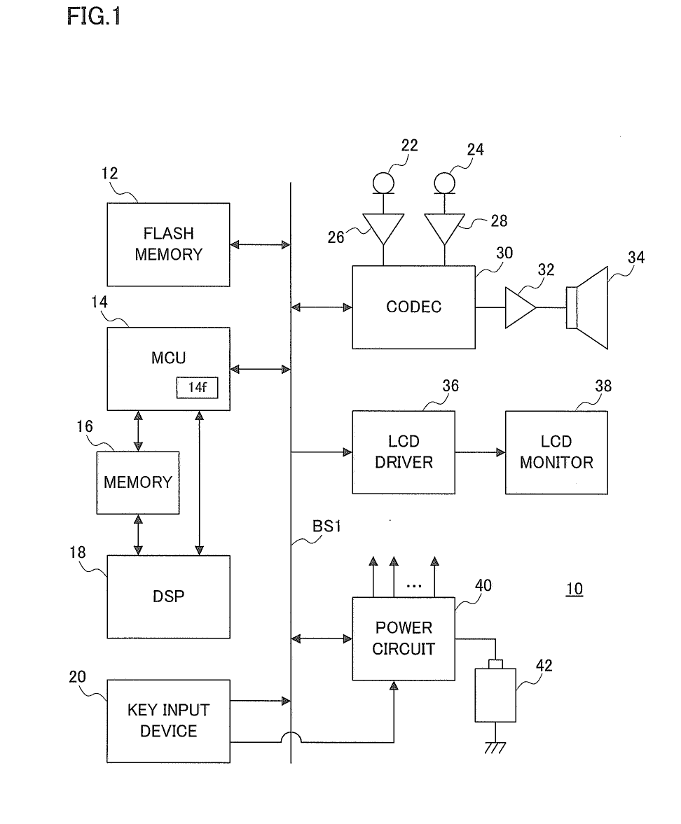

With reference to FIG. 1, an IC recorder 10 according to this embodiment includes a key input device 20. When a power-supply input manipulation is performed by the key input device 20, a power based on a battery 42 is supplied to a whole system by a power supply circuit 40. Thereby, the IC recorder 10 is started.

When an audio reproducing manipulation is performed by the key input device 20 after the power supply is inputted, an RISC-type MCU 14 issues a decompressing command and a decoding command to a DSP 18 and a codec 30, respectively, in order to start an audio reproducing mode, and reads out an audio file stored in a detachable flash memory 12, such as a memory card, through a bus BS1. The read-out audio file is applied to the DSP 18 through a memory 16.

The DSP 18 decompresses compressed audio data included in the applied audio file, and accumulates the decompressed audio data in the memory 16. The MCU 14 applies the audio data accumulated in the memory 16, to the codec 30 through the bus BS1. The codec 30 decodes the applied audio data into an analog audio signal, and outputs the decoded audio signal from a speaker 34 through an amplifier 32.

Furthermore, the MCU 14 commands an LCD controller 36 to output mode information “audio reproducing mode”. The mode information is displayed on an LCD monitor 38. Thus, a processing operation according to the audio reproducing mode is realized. The started audio reproducing mode is stopped when a stop manipulation is performed by the key input device 20 or when a flag FLG1 indicates “1”.

The flag FLG1 is a flag for permitting/prohibiting the processing operation according to the audio reproducing mode (and an audio recording mode described later). FLG1=0 indicates permission while FLG1=1 indicates prohibition. The flag FLG1 is set to “0” initially when the power supply is inputted, and is updated to “1” when a predetermined condition described later is satisfied.

When the audio recording manipulation is performed by the key input device 20, the MCU 14 issues an encoding command and a compressing command to the codec 30 and the DSP 18, respectively, in order to start the audio recording mode. The codec 30 encodes an audio signal captured by microphones 22 and 24 and amplified by amplifiers 26 and 28, into digital audio data, and applies the encoded digital audio data to the MCU 14 through the bus BS1. The MCU 14 applies the applied audio data to the DSP 18 through the memory 16.

The DSP 18 compresses the applied audio data, and accumulates the compressed audio data into the memory 16. The MCU 14 stores the compressed audio data accumulated in the memory 16, in the flash memory 12 in a file format.

Furthermore, in order to display mode information “audio recording mode” on the LCD monitor 38, the MCU 14 commands the LCD controller 36 to output this mode information. Thus, the processing operation according to the audio recording mode is realized. The started audio recording mode is stopped when a stop manipulation is performed by the key input device 20 or when the flag FLG1 indicates “1”.

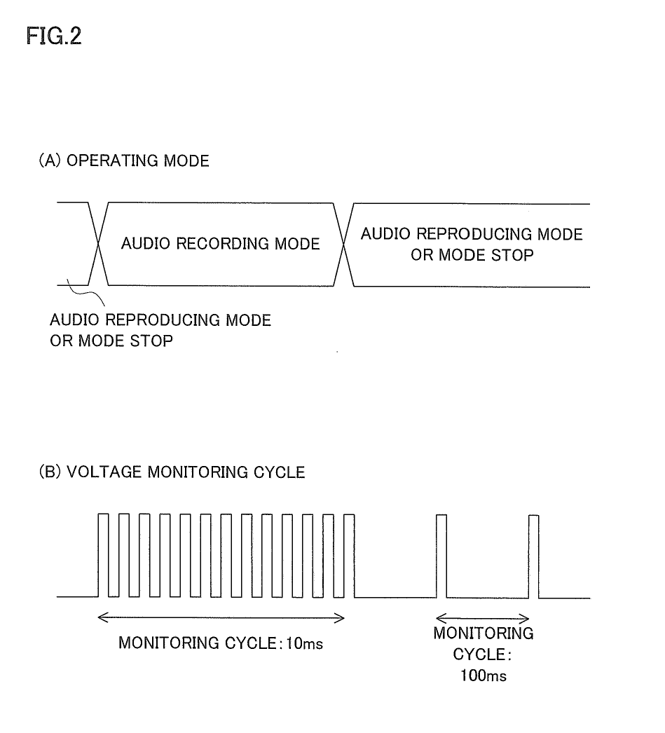

With reference to FIG. 2(A) and FIG. 2(B), when the operating mode at a current time point is the audio recording mode, the MCU 14 fetches a terminal voltage Vbat of the battery 42 for each 10 milliseconds, and compares the fetched terminal voltage Vbat with a threshold value THv. When a comparison result indicating the terminal voltage Vbat≦the threshold value THv is continued for two consecutive times, the MCU 14 updates the flag FLG1 from “0” to “1” in order to stop the audio recording mode.

On the other hand, when the operating mode at a current time point is the audio reproducing mode, the MCU 14 fetches the terminal voltage Vbat of the battery 42 for each 100 milliseconds, and compares the fetched terminal voltage Vbat with the threshold value THv. When a comparison result indicating the terminal voltage Vbat≦the threshold value THv is continued for three consecutive times, the MCU 14 updates the flag FLG1 from “0” to “1” in order to stop the audio reproducing mode.

Thus, a cycle for determining whether or not the terminal voltage Vbat of the battery 42 is equal to or less than the threshold value THv differs depending on each operating mode. When the determination result indicating the terminal voltage Vbat≦the threshold value THv is continued for a designated number of times, the processing operation according to the operating mode at a current time point is stopped. Thereby, a timing at which the processing operation is stopped is adaptively adjusted for each operating mode, resulting in improvement of a stability of the processing operation.

Moreover, a current load or a power consumption in the audio recording mode is larger than a current load or a power consumption in the audio reproducing mode, and a cycle for determining a magnitude of the terminal voltage Vbat in the audio recording mode is shorter than a cycle for determining a magnitude of the terminal voltage Vbat in the audio reproducing mode. In other words, a cycle for determining whether or not the terminal voltage Vbat is equal to or less than the threshold value THv is shortened with an increase in the current load or the power consumption. As a result, it becomes possible to avoid as much as possible an instance where data in the flash memory 12 is destructed resulting from a forced ending of writing the data in the flash memory 12 in the audio recording mode.

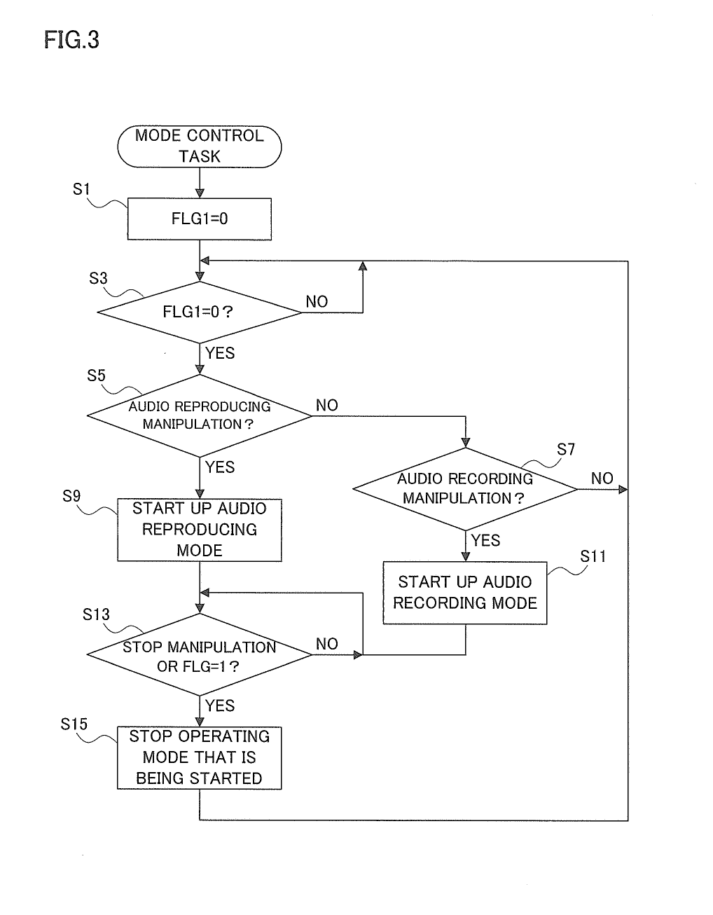

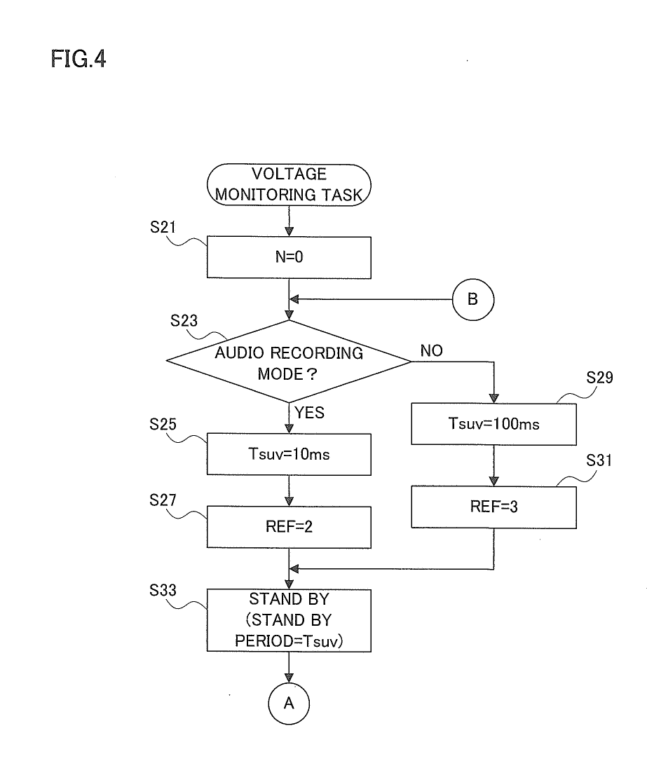

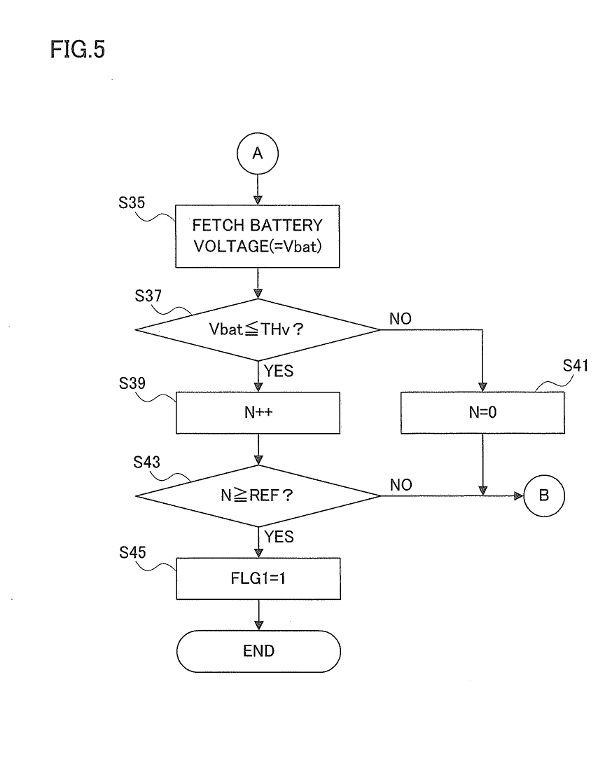

The MCU 14 executes in parallel a plurality of tasks including a mode controlling task shown in FIG. 3 and a voltage monitoring task shown in FIG. 4 and FIG. 5. It is noted that control programs corresponding to these tasks are stored in an internal flash memory 14f.

With reference to FIG. 3, in a step S1, the flag FLG1 is set to “0”. In a step S3, it is determined whether or not the flag FLG1 is “0”. When NO is determined, the process returns to the step S3 while when YES is determined, the process advances to a step S5. In a step S5, it is determined whether or not the audio reproducing manipulation is performed, and in a step S7, it is determined whether or not the audio recording manipulation is performed. When YES is determined in the step S5, the process advances to a step S9 so as to start the audio reproducing mode. When YES is determined in the step S7, the process advances to a step S11 so as to start the audio recording mode.

Upon completion of the process in the step S9 or S11, whether or not the stop manipulation is performed and whether or not the flag FLG1 is updated from “0” to “1” are determined in a step S13. When the stop manipulation is not performed, and furthermore, the flag FLG1 maintains “0”, the process in the step S11 is repeated. On the other hand, when the stop manipulation is performed or the flag FLG1 is updated to “1”, the operating mode that is being started is stopped in a step S15, and thereafter, the process returns to the step S3.

With reference to FIG. 4, a variable N is set to “0” in a step S21. In a step S23, it is determined whether or not the operating mode at a current time point is the audio recording mode. When YES is determined in the step S23, the process undergoes steps S25 to S27, and then, advances to a step S33. On the other hand, when NO is determined in the step S23, i.e., when the operating mode at a current time point is the audio reproducing mode or the audio recording mode and the audio reproducing mode are both in a stopped state, the process undergoes steps S29 to S31, and then, advances to the step S33.

In the step S25, a monitoring cycle Tsuv is set to 10 milliseconds, and in the step S27, a reference value REF is set to “2”. In the step S29, the monitoring cycle Tsuv is set to 100 milliseconds, and in the step S31, the reference value REF is set to “3”.

In the step S33, only during a period equivalent to the monitoring cycle Tsuv, the process stands by. When the period equivalent to the monitoring cycle Tsuv is elapsed, the terminal voltage Vbat of the battery 42 is fetched in a step S35, and whether or not the fetched terminal voltage Vbat is equal to or less than the threshold value voltage THv is determined in a step S37.

When the terminal voltage Vbat exceeds the threshold value voltage THv, the variable N is restored to “0” in a step S41, and thereafter, the process returns to the step S23. On the other hand, when the terminal voltage Vbat is equal to or less than the threshold value voltage THv, the variable N is incremented in a step S39, and whether or not the incremented variable N reaches the reference value REF is determined in a step S43. Then, when the variable N falls below the reference value REF, the process returns to the step S23 while when the variable N is equal to or more than the reference value REF, the flag FLG1 is set to “1” in a step S45, and thereafter, the process is ended.

As can be seen from the above description, the MCU 14 executes the processing operation according to one of the audio reproducing mode and the audio recording mode, by using the battery 42 as a power supply (S5, S7, S9, and S11). Also, the MCU 14 cyclically determines, in parallel with the processing operation according to the operating mode at a current time point, whether or not the terminal voltage Vbat of the battery 42 is equal to or less than the threshold value THv (S35 to S43), and when the determination result is updated from a negative result to an affirmative result, the MCU 14 requests to stop the processing operation according to the operating mode at a current time point (S45). Moreover, the MCU 14 adjusts a length of the cycle in which the above-described determining process is performed to a length different depending on each operating mode (S23, S25, and S29).

Thus, the cycle in which whether or not the terminal voltage Vbat of the battery 42 is equal to or less than the threshold value THv is determined differs depending on each operating mode. When the terminal voltage Vbat of the battery 42 becomes equal to or less than the threshold value THv, the processing operation according to the operating mode at a current time point is stopped. Thereby, the timing at which the processing operation is stopped is adaptively adjusted for each operating mode, resulting in improvement of a stability of the processing operation.

Furthermore, the current load or the power consumption in the audio recording mode is larger than the current load or the power consumption in the audio reproducing mode, and the cycle for determining whether or not the terminal voltage Vbat is equal to or less than the threshold value THv is shortened with an increase in the current load or the power consumption. As a result, it is possible to avoid as much as possible an instance where data in the flash memory 12 is destructed resulting from a forced ending of writing the data in the flash memory 12 in the audio recording mode.

It is noted that in this embodiment, as the operating modes, the audio recording mode and the audio reproducing mode are assumed. However, it may be optionally possible that the audio recording mode is categorized into a high-bit-rate recording mode and a low-bit-rate recording mode and a determining cycle of the terminal voltage Vbat is differed between the high-bit-rate recording mode and the low-bit-rate recording mode.

Furthermore, in this embodiment, over the whole period during which the audio recording mode is started, the determining cycle of the terminal voltage Vbat is shortened. However, over only a partial period during which the MPU 14 accesses the flash memory 12, out of the period during which the audio recording mode is started, the determining cycle of the terminal voltage Vbat may be optionally shortened.

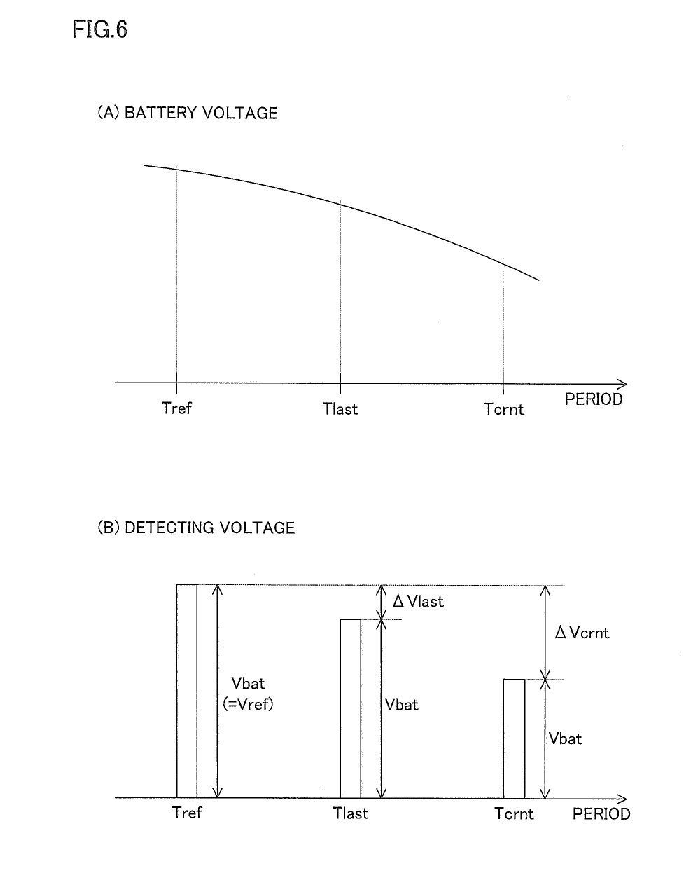

Moreover, in this embodiment, the terminal voltage Vbat of the battery 42 is compared with the threshold value THv to control the flag FLG1 (see steps S35 to S45 in FIG. 5). However, the terminal voltage Vbat of the battery 42 is reduced with time in a manner shown in FIG. 6(A), and also the terminal voltage Vbat fetched in the step S35 shown in FIG. 5 is reduced with time in a manner shown in FIG. 6(B).

Therefore, the terminal voltage Vbat at a reference time Tref is regarded as a reference voltage Vref, and a drop amount (ΔVlast at a time Tlast and ΔVcmt at a time Tcmt) from the reference voltage Vref is compared with a threshold value ΔTHv. In this way, the flag FLG1 may be optionally controlled.

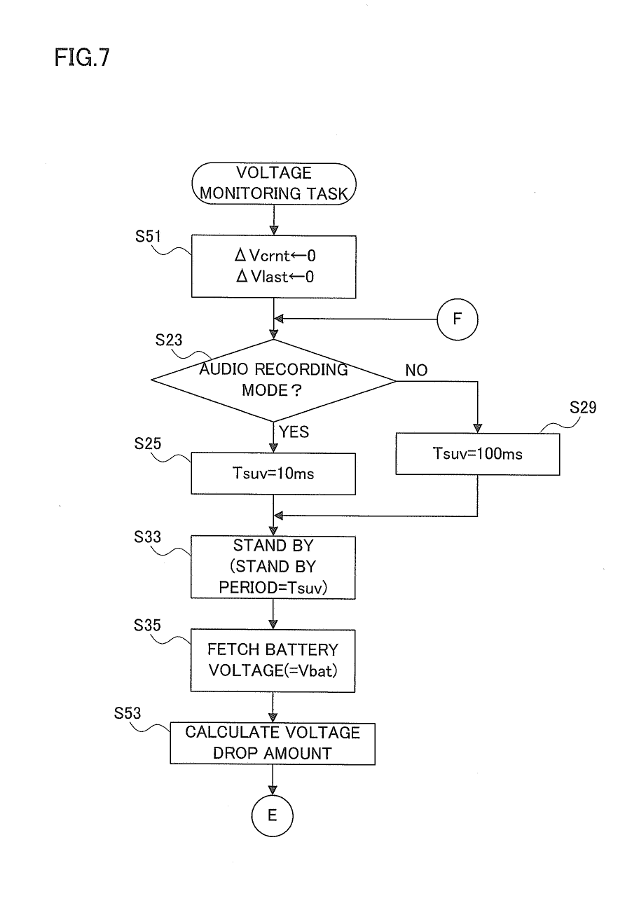

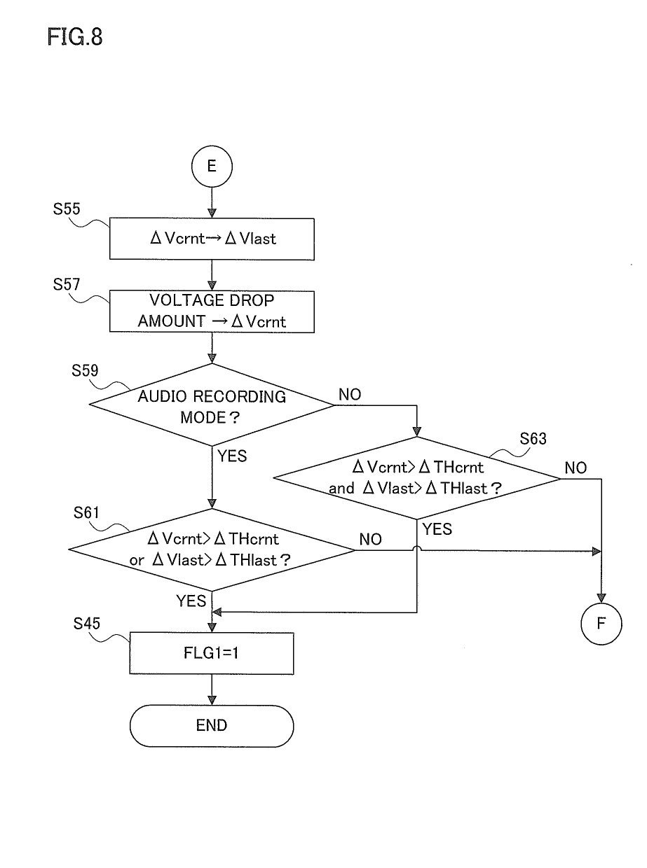

In this case, it is needed to execute a voltage monitoring task shown in FIG. 7 and FIG. 8 instead of the voltage monitoring task shown in FIG. 4 and FIG. 5. It is noted that the voltage monitoring task shown in FIG. 7 and FIG. 8 is the same as that shown in FIG. 4 and FIG. 5 except that: a process in a step S51 shown in FIG. 7 is added; the processes in the steps S27 and S29 shown in FIG. 4 are omitted; and processes shown in steps S53 to S63 shown in FIG. 7 and FIG. 8 are executed instead of the processes shown in steps S37 to S43 shown in FIG. 5. Therefore, the duplicated description relating to the same processes is omitted as much as possible.

With reference to FIG. 7, in the step S51, the variables ΔVcmt and ΔVlast are set to “0”. In the step S53, with reference to the terminal voltage Vbat of the battery 42 fetched in the step S35, a voltage drop amount (=Vref−Vbat) from the reference voltage Vref is calculated. In the step S55, the variable ΔVcmt is set to the variable ΔVlast, and in the step S57, the voltage drop amount calculated in the step S53 is set to the variable ΔVcmt.

In the step S59, it is determined whether or not the operating mode at a current time point is the audio recording mode. When YES is determined, the process advances to a determining process in the step S61 while when NO is determined, the process advances to a determining process in the step S63. Then, when NO is determined in the step S61 or S63, the process returns to the step S23 while when YES is determined in the step S61 or S63, the process advances to the step S45.

In the step S61, when the variable ΔVcmt exceeds the threshold value ΔTHcmt or the variable ΔVlast exceeds the threshold value ΔTHlast, YES is determined, and when the variable ΔVcmt is equal to or less than the threshold value ΔTHcmt and the variable ΔVlast is equal to or less than the threshold value ΔTHlast, NO is determined.

In the step S63, when the variable ΔVcmt exceeds the threshold value ΔTHcmt and the variable ΔVlast exceeds the threshold value ΔTHlast, YES is determined, and when the variable ΔVcmt is equal to or less than the threshold value ΔTHcmt or the variable ΔVlast is equal to or less than the threshold value ΔTHlast, NO is determined.

When such a voltage monitoring task is executed, a timing at which the processing operation is stopped is adaptively adjusted for each operating mode, resulting in improvement of a stability of the processing operation. Moreover, it is possible to avoid as much as possible an instance where data in the flash memory 12 is destructed resulting from a forced ending of writing the data in the flash memory 12 in the audio recording mode.

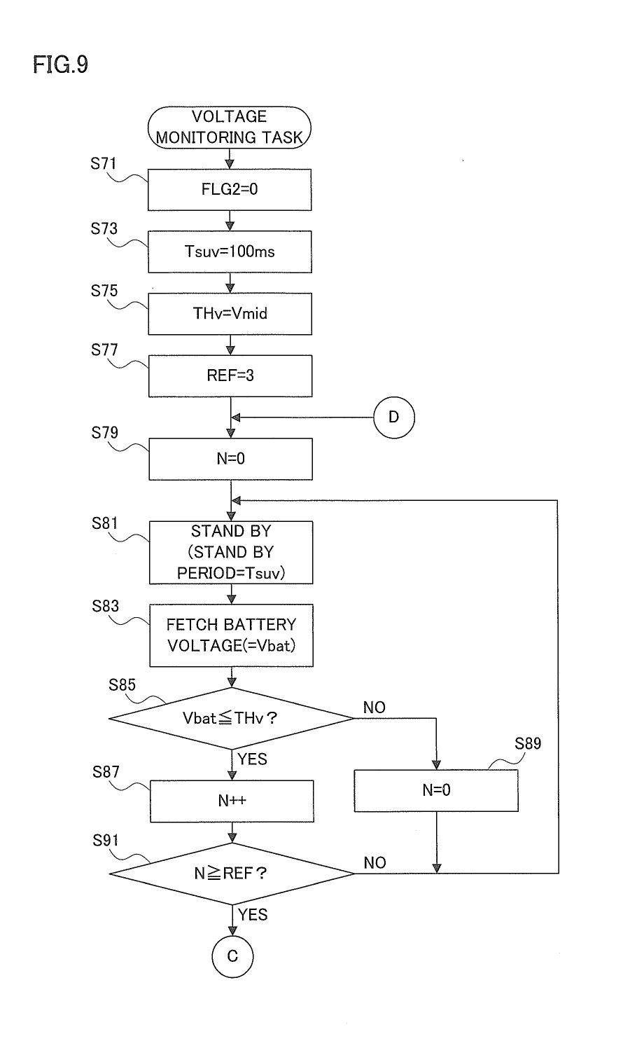

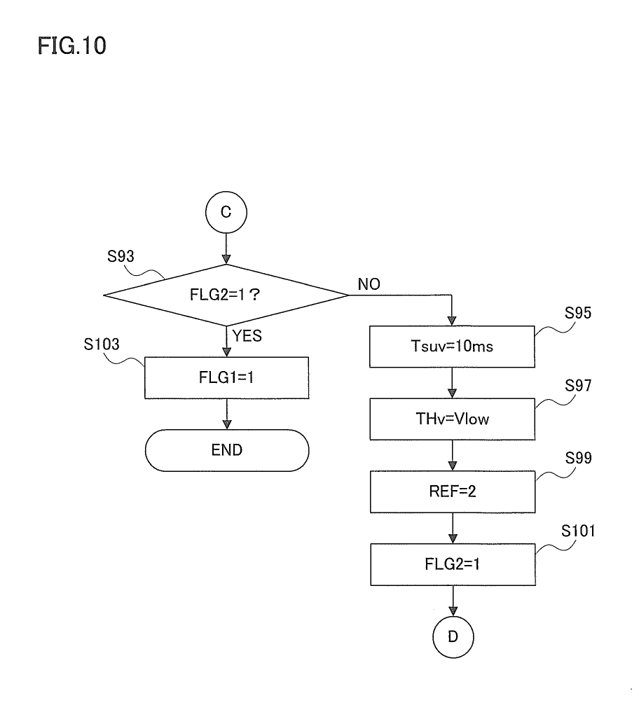

Moreover, in this embodiment, the voltage monitoring task shown in FIG. 4 and FIG. 5 is executed. However, instead of the voltage monitoring task shown in FIG. 4 and FIG. 5 is executed, a voltage monitoring task shown in FIG. 9 and FIG. 10 may be optionally executed.

With reference to FIG. 9, in a step S71, a flag FLG2 is set to “0”, and in a step S73, the monitoring cycle Tsuv is set to 100 milliseconds. Moreover, in a step S75, the threshold value voltage THv is set to a voltage Vmid, and in a step S77, the reference value REF is set to “3”.

In a step S79, the variable N is set to “0”, and in a step S81, only during a time period equivalent to the monitoring cycle Tsuv, the process stands by. When the period equivalent to the monitoring cycle Tsuv is elapsed, the terminal voltage Vbat of the battery 42 is fetched in a step S83, and whether or not the fetched terminal voltage Vbat is equal to or less than the threshold value voltage THv is determined in a step S85.

When the terminal voltage Vbat>the threshold value voltage THv is established, the variable N is set to “0” in a step S89, and thereafter, the process returns to the step S81. On the other hand, when the terminal voltage Vbat≦the threshold value voltage THv is established, the variable N is incremented in a step S87, and whether or not the incremented variable N reaches the reference value REF is determined in a step S91. Then, when the variable N falls below the reference value REF, the process returns to the step S81 while when the variable N is equal to or more than the reference value REF, the process advances to a step S93.

In a step S93, it is determined whether or not the flag FLG2 is “1”. When NO is determined, the process advances to a step S95. In the step S95, the monitoring cycle Tsuv is set to 10 milliseconds, in a step S97, the threshold value voltage THv is set to a voltage Vlow (Vlow: voltage that falls below Vmid), and in a step S99, the reference value REF is set to “2”. Upon completion of the process in the step S99, the process sets the flag FLG2 to “1” in a step S101, and then, returns to the step S79. When YES is determined in the step S93, the process sets the flag FLG1 to “1” in a step S103, and thereafter, ends the process.

When such a voltage monitoring task is executed, the cycle for determining whether or not the terminal voltage Vbat of the battery 42 is equal to or less than the threshold value voltage THv is set to a length different depending on each magnitude of the terminal voltage Vbat of the battery 42, and when it is determined that the terminal voltage of the battery 42 is equal to or less than the threshold value voltage THv, the processing operation according to the operating mode at a current time point is stopped. Thereby, the timing at which the processing operation is stopped is adaptively adjusted in consideration of the magnitude of the terminal voltage Vbat of the battery 42, resulting in improvement of a stability of the processing operation.

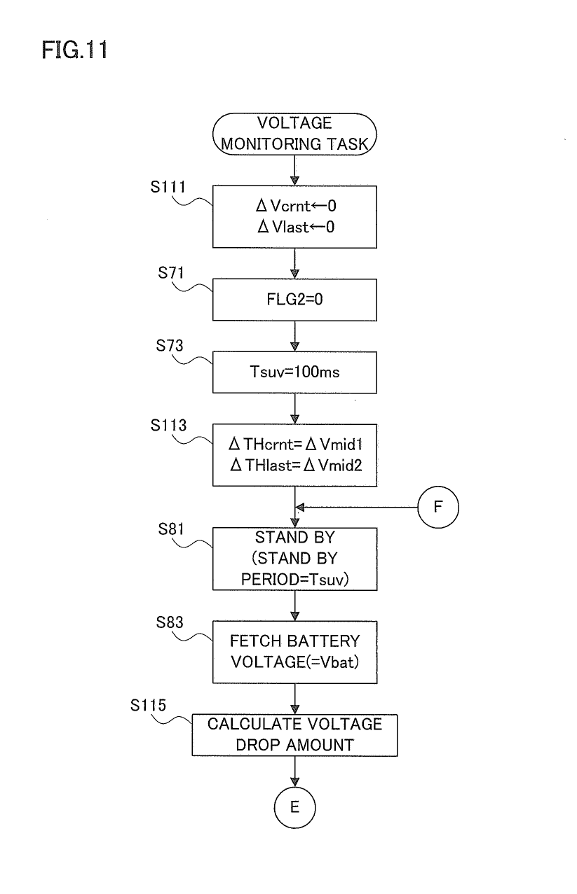

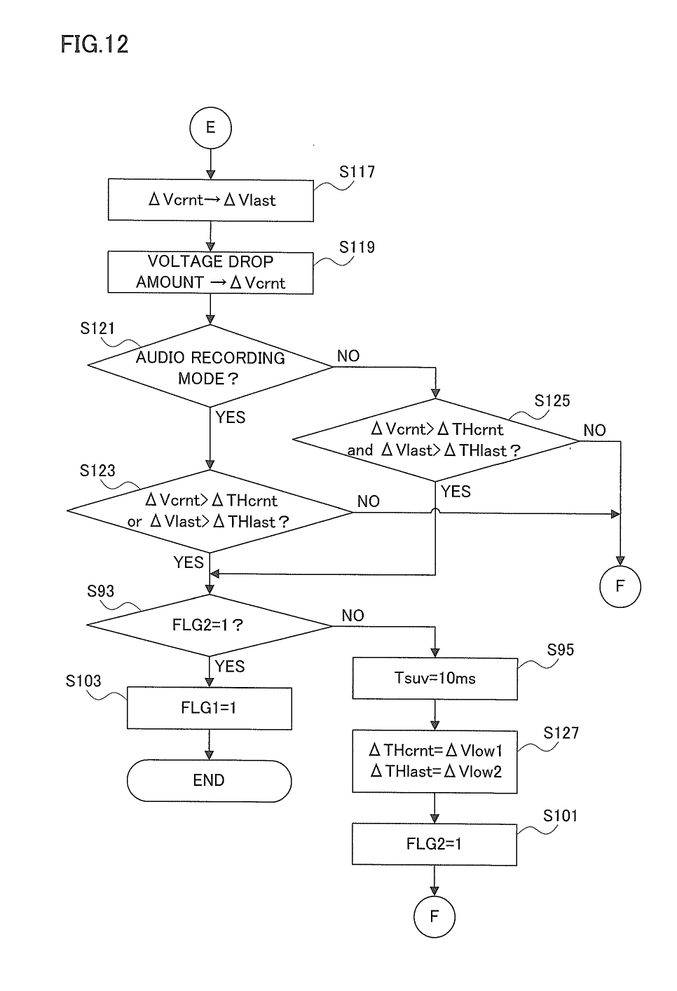

It is noted that instead of the voltage monitoring task shown in FIG. 9 and FIG. 10, a voltage monitoring task shown in FIG. 11 and FIG. 12 may be optionally executed. However, the voltage monitoring task shown in FIG. 11 and FIG. 12 is the same as that shown in FIG. 9 and FIG. 10 except that: a process in a step S111 shown in FIG. 11 is added; instead of the processes in the steps S75 to S79 shown in FIG. 9, a process in a step S113 shown in FIG. 11 is executed; instead of the processes in the steps S85 to S91 shown in FIG. 9, processes in steps S115 to S125 shown in FIG. 11 and FIG. 12 are executed; and instead of the processes in the steps S97 to S99 shown in FIG. 10, a process in a step S127 shown in FIG. 12 is executed. Therefore, the duplicated description relating to the same processes is omitted as much as possible.

In the step S111 shown in FIG. 11, the variable ΔVcmt and the ΔVlast are set to “0”. In the step S113, the threshold value ΔTHcmt is set to a voltage drop amount ΔVmid1, and at the same time, the threshold value ΔTHlast is set to a voltage drop amount ΔVmid2. In the steps S115 to S125, processes similar to those in the above-described steps S53 to S63 (see FIG. 7 and FIG. 8) are executed. When NO is determined in the step S123 or S125, the process returns to the step S81 while when YES is determined in the step S123 or S125, the process advances to the step S93.

In the step S127, the threshold value ΔTHcmt is set to a voltage drop amount ΔVlow1 (ΔVlow1: voltage drop amount exceeding ΔVmid1), and at the same time, the threshold value ΔTHlast is set to a voltage drop amount ΔVlow2 (ΔVlow2: voltage drop amount exceeding ΔVmid2).

Thereby, the timing at which the processing operation is stopped is adaptively adjusted in consideration of the magnitude of the terminal voltage Vbat of the battery 42, resulting in improvement of a stability of the processing operation.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A mode processing apparatus, comprising:
a processor which executes a processing operation according to any one of a plurality of operating modes under a battery power supply;
a determiner which cyclically determines, in parallel with the processing operation of said processor, whether or not a voltage fluctuation of the battery power supply matches a predetermined condition;
a requester which requests said processor to stop the processing operation when a determination result of said determiner is updated from a negative result to an affirmative result; and
an adjuster which adjusts a length of a determining cycle of said determiner to a length different depending on each operating mode noticed by said processor.

2. A mode processing apparatus according to claim 1, wherein said adjuster shortens the length of the determining cycle with an increase in a power consumption.

3. A mode processing apparatus according to claim 1, wherein the processing operation executed by said processor includes an access operation to access a recording medium.

4. A mode processing apparatus according to claim 1, wherein the predetermined condition includes a voltage value condition under which a voltage value of the battery power supply is equal to or less than a threshold value.

5. A mode processing apparatus according to claim 1, wherein the predetermined condition includes a voltage drop amount condition under which a voltage drop amount of the battery power supply exceeds a reference.

6. A mode processing apparatus according to claim 5, further comprising a modifier which modifies a content of the reference according to the operating mode noticed by said processor.

7. A mode processing apparatus according to claim 6, wherein the reference includes a first reference in which a plurality of voltage drop amounts respectively corresponding to a plurality of time points different to one another all exceed the threshold value and a second reference in which at least one of a plurality of voltage drop amounts respectively corresponding to a plurality of time points different to one another exceeds the threshold value.

8. A mode processing program product executed by a processor of a mode processing apparatus, said mode processing program product comprising:
a processing step of executing a processing operation according to any one of a plurality of operating modes under a battery power supply;
a determining step of cyclically determining, in parallel with the processing operation in said processing step, whether or not a voltage fluctuation of the battery power supply matches a predetermined condition;
a requesting step of requesting said processing step to stop the processing operation when a determination result in said determining step is updated from a negative result to an affirmative result; and
an adjusting step of adjusting a length of a determining cycle in said determining step to a length different depending on each operating mode noticed by said processing step.

9. A mode processing method executed by a mode processing apparatus, said mode processing method comprising:
a processing step of executing a processing operation according to any one of a plurality of operating modes under a battery power supply;
a determining step of cyclically determining, in parallel with the processing operation in said processing step, whether or not a voltage fluctuation of the battery power supply matches a predetermined condition;
a requesting step of requesting said processing step to stop the processing operation when a determination result of said determining step is updated from a negative result to an affirmative result; and
an adjusting step of adjusting a length of a determining cycle in said determining step to a length different depending on each operating mode noticed by said processing step.

10. A mode processing apparatus, comprising:
a processor which executes a predetermined processing operation under a battery power supply;
a determiner which cyclically determines, in parallel with the processing operation in said processor, whether or not a voltage fluctuation of the battery power supply matches a predetermined condition;
a requester which requests said processor to stop the processing operation when a determination result in said determiner is updated from a negative result to an affirmative result; and
an adjuster which adjusts a length of a determining cycle in said determiner to a length different depending on each magnitude of a voltage of the battery power supply.
